(19) United States
(12) Patent Application Publication
(10) Pub. No.: US 2026/0152105 A1
(43) Pub. Date: Jun. 4, 2026

(54) ARMREST ASSEMBLY, VEHICLE, AND METHOD FOR PROVIDING A TRAY TABLE

(71) Applicant: FAURECIA AUTOMOTIVE INTERIOR SYSTEM (SHANGHAI) CO., LTD., Shanghai (CN)

(72) Inventor: JUNJIE TANG, Shanghai (CN)

(21) Appl. No.: 19/409,640

(22) Filed: Dec. 4, 2025

(30) Foreign Application Priority Data
Dec. 4, 2024 (CN) 202411777156.0

(51) Int. Cl. B60N 2/75; B60N 3/00

(52) U.S. Cl. CPC B60N 2/793; B60N 3/002

(57) ABSTRACT

The present disclosure provides an armrest assembly, a vehicle, and a method for providing a tray table. And the armrest assembly includes a shell, providing a storage space and a cover, being set correspondingly to an opening of the storage space, and the cover being connected to the shell via a movement mechanism, and the cover being able to move relative to the shell to open or close the storage space; wherein, when the cover is disengaged from the opening of the storage space to open the storage space, the cover is able to move to a first position and/or a second position via the movement mechanism, and the cover located at the first position or the second position provides a placement surface, and the placement surface is able to support an item, and at least part of the placement surface exceeds side boundary of the shell.

### CROSS-REFERENCE TO RELATED APPLICATION

This application claims priority of Chinese Patent Application No. 202411777156.0, filed on Dec. 4, 2024, the contents of which are entirely incorporated herein by reference.

### FIELD

The present disclosure relates to an armrest assembly, a vehicle, and a method for providing a tray table.

### BACKGROUND

Armrest assemblies, such as center console armrests of vehicle interiors, are provided with armrest boxes having a storage function for storing small items such as beverages and cups, allowing users to easily access these items when needed. Armrest boxes can also be referred to as armrest compartments, central armrest storage boxes, storage containers, etc.

In some embodiments, a foldable tray table is provided in the storage box. When the foldable tray table needs to be used, it is taken out from the storage box and unfolded for the user to place items such as mobile phones, tablet computers, or food.

However, this causes the tray table to occupy the storage space when folded and not in use, thereby reducing the original storage function of the storage space.

### SUMMARY

The present disclosure provides an armrest assembly.

The present disclosure provides a vehicle.

The present disclosure provides a method for providing a tray table.

The present disclosure provides an armrest assembly according to embodiments of the disclosure. The armrest assembly includes a shell, providing a storage space; and a cover, being set correspondingly to an opening of the storage space, and the cover being connected to the shell via a movement mechanism, and the cover being able to move relative to the shell to open or close the storage space; and when the cover is disengaged from the opening of the storage space to open the storage space, the cover is able to move to a first position and/or a second position via the movement mechanism, and the cover located at the first position or the second position provides a placement surface, and the placement surface is able to support an item, and at least part of the placement surface exceeds side boundary of the shell.

In some embodiments of the present disclosure, the movement mechanism includes a first connecting arm and a second connecting arm, the first connecting arm being connected to the cover, and the first connecting arm including an arm portion extending along a third direction and a rotating shaft portion connected to the arm portion, and a first rotating axis provided by the rotating shaft portion extending in a second direction; and the first connecting arm and the second connecting arm being rotatably connected, the first connecting arm being able to rotate relative to the second connecting arm around a second rotating axis and/or around a third rotating axis, and the second rotating axis extending in the first direction, the third rotating axis extending in the third direction, and the first direction, the second direction, and the third direction being perpendicular to each other.

In some embodiments of the present disclosure, the first connecting arm and the second connecting arm are liftable parts in the Z direction, and when the cover is disengaged from the opening of the storage space to open the storage space, the first connecting arm and the second connecting arm can be lifted to an extended position in the Z direction, and a lifting stroke of the liftable parts is limited by a locking mechanism.

In some embodiments of the present disclosure, an inner surface of the cover corresponds to the opening and being able to close the storage space, and when the cover is disengaged from the opening of the storage space to open the storage space, the inner surface serves as the placement surface after rotating around the second rotation axis and around the third rotation axis.

In some embodiments of the present disclosure, the cover is connected to the first connecting arm through the rotating shaft portion, and the rotating shaft portion is set with a damping torque, when a lock between the cover and the shell is released, the cover is able to be driven by a manual opening force against the damping torque to rotate around the first rotation axis to an open position and be hold at the open position.

In some embodiments of the present disclosure, a front end of the cover in the X direction is connected to the shell through a first movement mechanism, and a rear end of the cover in the X direction is connected to the shell through a second movement mechanism.

In some embodiments of the present disclosure, the first position is located on one side boundary of the shell in the Y direction, and the second position is located on the other side boundary of the shell in the Y direction, and angle between the placement surface at the first position and the placement surface at the second position is 180°.

In addition, the present disclosure provides a vehicle according to embodiments of the disclosure, and the vehicle includes the armrest assembly as described in the above embodiments.

In some embodiments of the present disclosure, the armrest assembly includes a center console armrest of a vehicle interior.

In addition, the present disclosure provides a method for providing a tray table according to embodiments of the disclosure. The method employs the armrest assembly as described in the above embodiments, and the method includes followings steps: disengaging the cover from the opening of the storage space to open the storage space; moving the cover to a first position or a second position through the movement mechanism, and the cover located at the first position or the second position serves as the tray table, providing the placement surface, and the placement surface is set to place an item.

### DESCRIPTION OF ATTACHED DRAWINGS

The above embodiments of the present disclosure will become more apparent through the following description in conjunction with the accompanying drawings and embodiments.

FIG. 1 is a schematic structural diagram of a vehicle and an armrest assembly according to an embodiment;

FIG. 2 is a cross-sectional structural diagram of an armrest assembly according to an embodiment;

FIG. 3 is a schematic structural diagram of an armrest assembly when the cover is closed according to an embodiment;

FIG. 4 is a schematic structural diagram of an armrest assembly when the front end in the first direction is opened according to an embodiment;

FIG. 5 is a schematic structural diagram of an armrest assembly when the rear end in the first direction is opened according to an embodiment;

FIGS. 6A to 6E are schematic structural diagrams of an armrest assembly when the cover moves to the first position or the second position according to an embodiment;

FIG. 7 is a schematic flow chart diagram of a method for providing a tray table according to an embodiment.

### REFERENCE NUMERALS

1000—Vehicle
1001—Center console armrest
100—Armrest assembly
1—Shell
11—Storage space 1
10—Opening of the storage space
2—Cover
21—Placement surface
22—Inner surface
23—Outer surface
201—First position
202—Second position
203—Open position
3—Movement mechanism
310—First movement mechanism
320—Second movement mechanism
30—Liftable part
301—Extended position
31—First connecting arm
311—Arm portion
312—Rotating shaft portion
32—Second connecting arm
401—First rotating axis
402—Second rotating axis
403—Third rotating axis
50—Locking mechanism
60—Gas spring.

### DETAILED DESCRIPTION OF EMBODIMENTS

Hereinafter, embodiments of the present disclosure will be described in detail with reference to the drawings. And embodiments are merely used to more clearly explain the embodiments of the present disclosure, and therefore are merely examples, and should not limit the scope of protection of the present disclosure.

Unless otherwise defined, all technical and scientific terms used herein have the same meaning as commonly understood in the art of the present disclosure. The terms used herein are for the purpose of describing embodiments only and not intended to limit the present disclosure; The terms “including” and “having” and any variations thereof in the specification and claims of the present disclosure and the above description of drawings are intended to cover non-exclusive inclusions.

In the embodiments of the present disclosure, the technical terms “first”, “second” and the like are only used to distinguish different objects, and should not be understood to indicate or imply relative importance or implicitly indicate the number, specific order, or primary-secondary relationship of the indicated technical features. In the embodiments of the present disclosure, “a plurality” means two or more unless otherwise explicitly and specifically defined.

An “embodiment” means that a particular feature, structure, or characteristic described may be included in at least one embodiment of the present disclosure. The appearance of the word “embodiment” in various places in the specification does not necessarily refer to the same embodiment, nor refer to an independent or other embodiment that is mutually exclusive from other embodiments. It may be explicitly and implicitly understood that the embodiments described herein may be combined with other embodiments.

In the embodiments of the present disclosure, the technical terms such as “center”, “longitude” , “latitude” , “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like are based on the orientation or positional relationships shown in the drawings, and are merely used to facilitate and simplify the description of the embodiments of the present disclosure, and do not indicate or imply that the referred device or element must have a specific orientation, be constructed and operated in a specific orientation, and therefore cannot be understood as a limitation of the embodiments of the present disclosure.

In the embodiments of the present disclosure, unless otherwise explicitly specified and defined, technical terms such as “mounted”, “linked”, “connected” and “fixed” should be understood in a broad sense, for example, they may be fixed connected, detachable connected, or integrated; It may also be a mechanical connection, and understanding of the specific meanings of the above terms in the embodiments of the present disclosure according to specific circumstances may be known.

It can be understood that flowcharts are used in the present disclosure to illustrate operations performed by the system according to embodiments of the present disclosure. It should be understood that, depending on the actual situation, the preceding or following operations are not necessarily performed precisely in order. One can also add additional steps to these procedures, or remove a step or steps from them.

Although the armrest assembly disclosed in the embodiments of the present disclosure is applicable to automobiles, it is not limited thereto. For example, it can be applied to other kinds of vehicles such as railway trains, ships, aircraft, etc., as long as the armrest assembly realizes the function of providing a foldable tray table, improves user experience, and avoids the defect that the tray table occupies the storage space when folded and not in use and reduces the original storage function of the storage space, the armrest assembly, vehicle, and method for providing a tray table disclosed in the embodiments can be applied.

In the following description, the first direction, the second direction, and the third direction are shown as X direction, Y direction, and Z direction in the figures, but are not limited thereto.

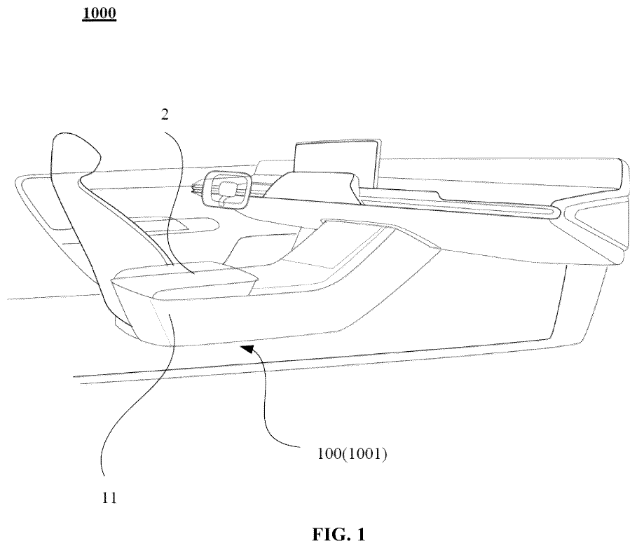

Referring to FIG. 1, an automobile is taken as an example of a vehicle 1000. The armrest assembly 100 can be a center console armrest 1001 arranged in the cockpit of the vehicle. The storage space 11 of the center console armrest 1001 is normally opened or closed by the cover 2. In the embodiments described below, it will be described in detail that the user can use the cover 2 of the armrest assembly 100 as a tray table to place items or provide support for the user's elbows, arms, and other body parts, improving the user's experience, and avoiding the defect that the tray table occupies the storage space when folded and not in use and reduces the original storage function of the storage space.

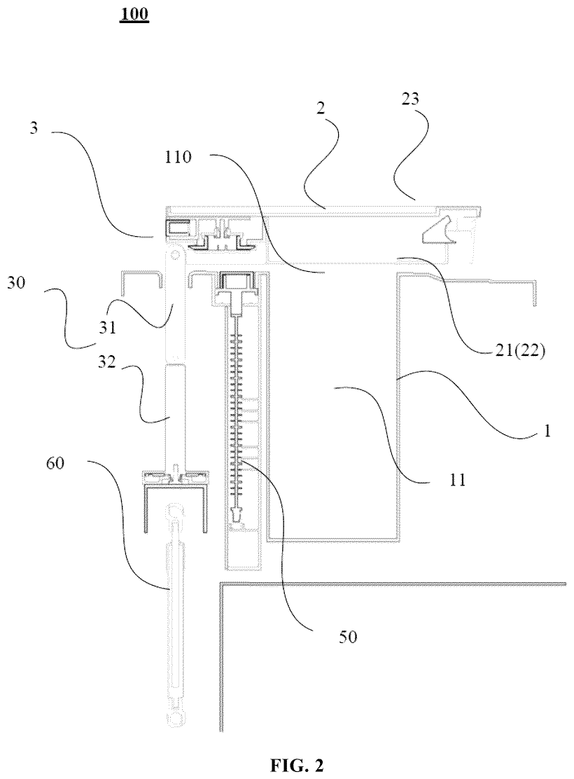

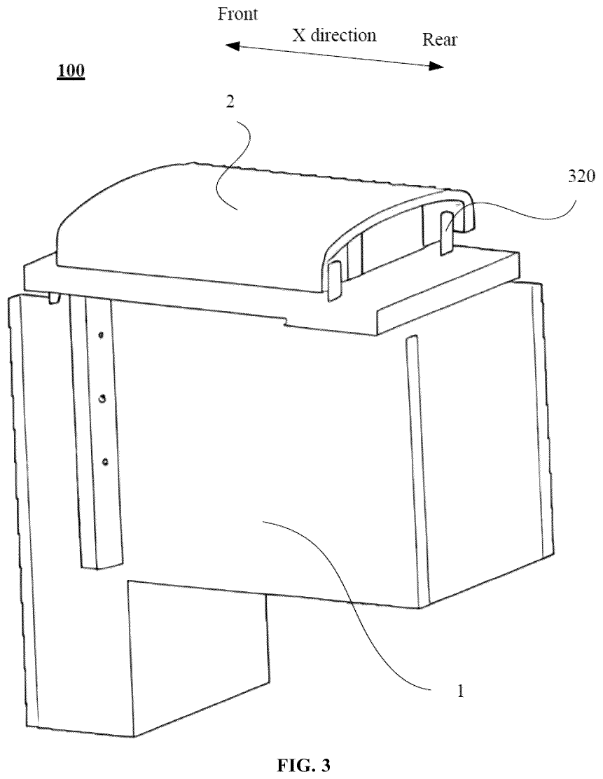

Referring to FIGS. 2 to 6E, in some embodiments, the armrest assembly 100 includes a shell 1, a cover 2, and a movement mechanism 3.

The shell 1 provides a storage space 11.

The cover 2 is disposed corresponding to the opening 110 of the storage space 11, and the cover 2 is connected to the shell 1 via the movement mechanism 3, enabling the cover 2 to move relative to the shell 1 to open or close the storage space 11.

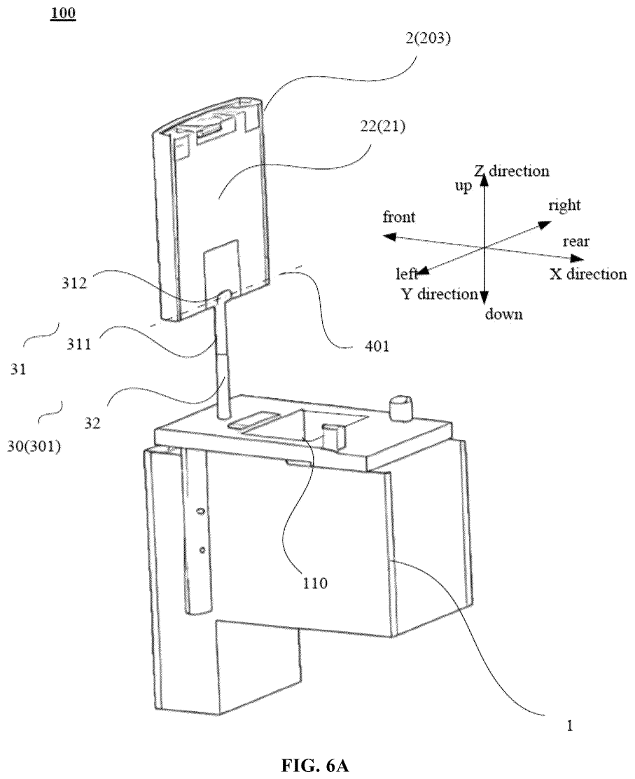

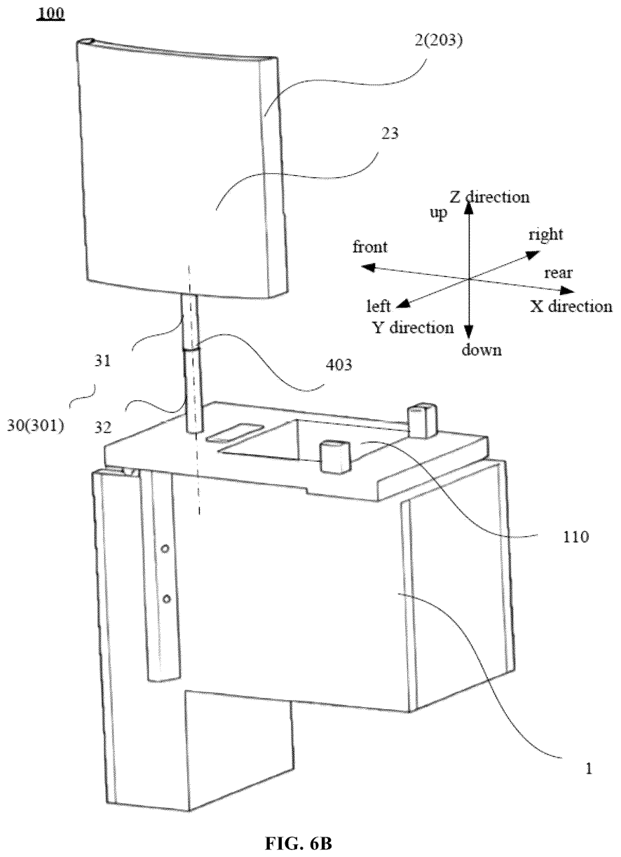

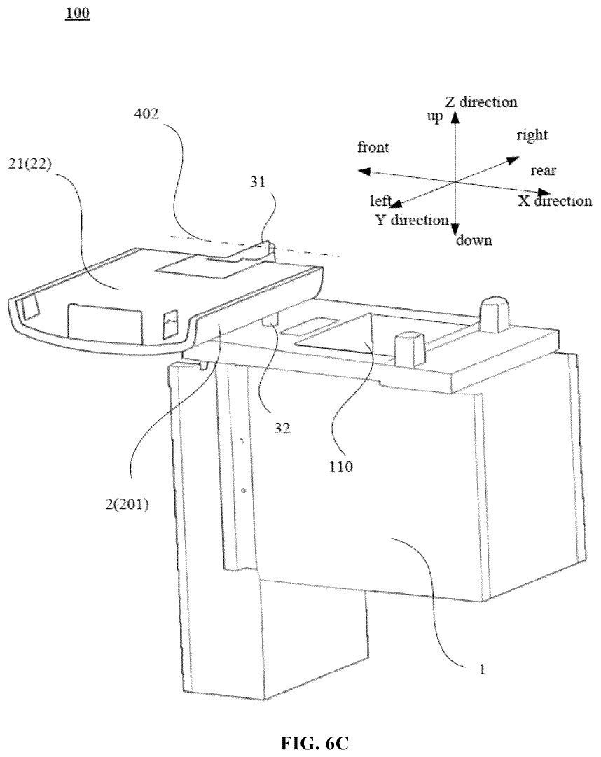

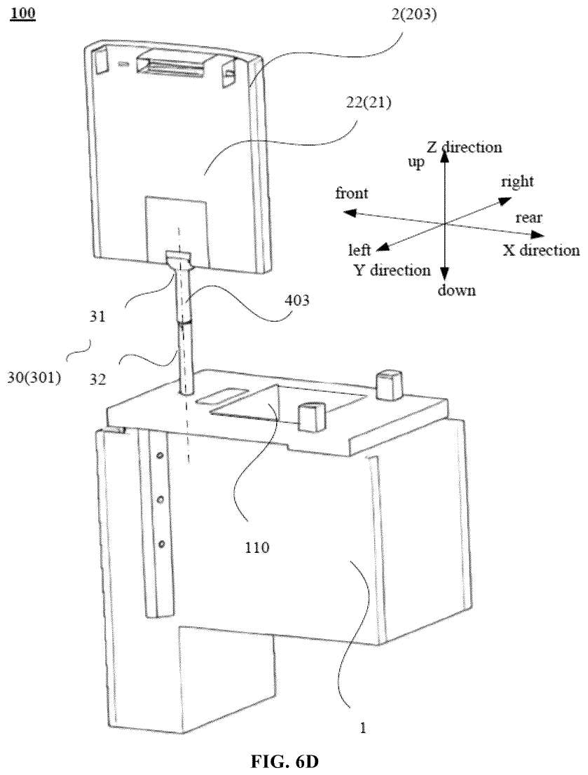

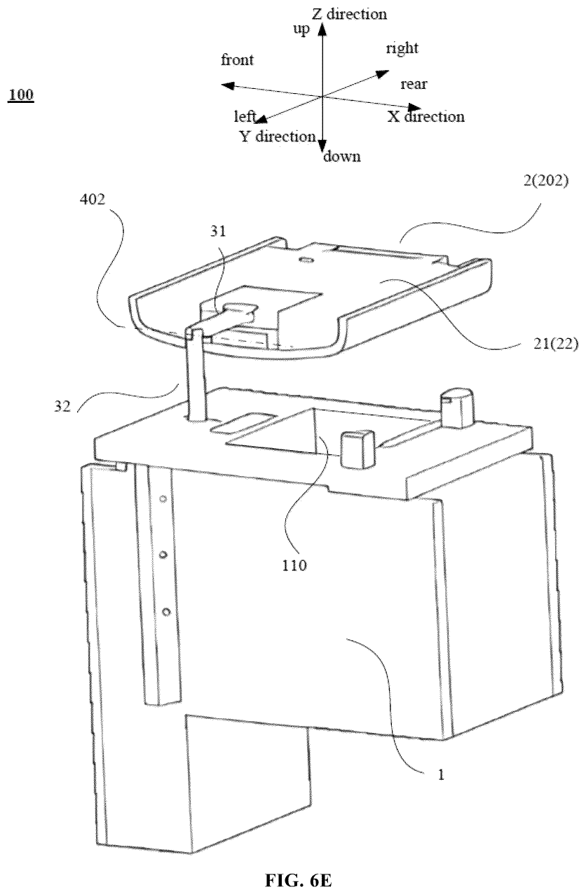

When the cover 2 is disengaged from the opening 110 of the storage space to open the storage space 11, as shown in FIGS. 6A to 6C, the cover 2 can move to a first position 201 via the movement mechanism 3, and/or as shown in FIGS. 6A, 6D, and 6E, the cover 2 can move to a second position 202 via the movement mechanism 3. The cover 2 located at the first position 201 or the second position 202 provides a placement surface 21, the placement surface 21 can support an item, and at least part of the placement surface 21 exceeds the side boundary of the shell 1, for example, exceeding the left and right boundaries of the shell 1 in the second direction (Y direction) as shown in the drawings.

The beneficial effect of the above embodiment is that by using the structure where the opened cover serves as the placement surface, not only the function of the armrest assembly providing a foldable tray table is realized to improve user experience, but also the defect that the tray table occupies the storage space when folded and not in use and reduces the original storage function of the storage space is avoided, further improving user experience.

Continuing to refer to FIGS. 2 to 6E, in some embodiments, the structure of the movement mechanism 3 is that the movement mechanism 3 includes a first connecting arm 31 and a second connecting arm 32, the first connecting arm 31 is connected to the cover 2, the first connecting arm 31 includes an arm portion 311 extending along the third direction (Z direction) and a rotating shaft portion 312 connected to the arm portion 311, and the first rotating axis 401 provided by the rotating shaft portion 312 extends in the second direction (Y direction); the first connecting arm 31 is rotatably connected to the second connecting arm 32, and the first connecting arm 31 can rotate relative to the second connecting arm 32 around the second rotating axis 402 and/or the third rotating axis 403. The second rotating axis 402 extends in the first direction (X direction), the third rotating axis 403 extends in the third direction (Z direction), and the first direction (X direction), the second direction (Y direction), and the third direction (Z direction) are perpendicular to each other.

The structure for the first connecting arm 31 to rotate relative to the second connecting arm 32 around the second rotating axis 402 and/or the third rotating axis 403 can be realized by common rotating structures such as ball hinges and couplings, and the detailed rotating structure will not be described in detail here.

A process for the cover 2 to move to the first position 201 via the movement mechanism 3 is shown in FIGS. 6A, 6B, and 6C. Firstly, as shown in FIG. 6A, the cover 2 rotates around the first rotating axis 401 to separate from the opening 110; then, as shown in FIG. 6B, the cover 2 rotates around the third rotating axis 403 and the inner surface 22 faces the right side in the second direction (Y direction); then, as shown in FIG. 6C, the cover 2 rotates around the second rotating axis 402 and the inner surface 22 faces upward to form the placement surface 21. At this time, the cover 2 moves to the first position 201, the placement surface 21 is able to support an item, and at least part of the placement surface 21 exceeds the left boundary of the shell 1.

Similarly, a process for the cover 2 to move to the second position 202 via the movement mechanism 3 is shown in FIGS. 6A, 6D, and 6E. Firstly, as shown in FIG. 6A, the cover 2 rotates around the first rotating axis 401 to separate from the opening 110; then, as shown in FIG. 6D, the cover 2 rotates around the third rotating axis 403 and the inner surface 22 faces the left side in the second direction (Y direction); then, as shown in FIG. 6E, the cover 2 rotates around the second rotating axis 402 and the inner surface 22 faces upward to form the placement surface 21. At this time, the cover 2 moves to the second position 202, the placement surface 21 can support an item, and at least part of the placement surface 21 exceeds the right boundary of the shell 1.

In some embodiments, as shown in FIG. 2, the first connecting arm 31 and the second connecting arm 32 are liftable parts 30 in the third direction (Z direction). When the cover 2 is disengaged from the opening 110 of the storage space to open the storage space 11, the first connecting arm 31 and the second connecting arm 32 can be lifted to the extended position 301 in the third direction (Z direction), and the lifting stroke of the liftable parts 30 is defined by the locking mechanism 50. The lifting driving force of the liftable parts 30 can be provided by the gas spring 60. For example, after the locking mechanism 50 is unlocked, the gas spring 60 releases elastic force to drive the liftable parts 30 to be lifted. When the cover 2 needs to be reset, the cover 2 is able to be pressed to overcome the resistance of the gas spring 60 to realize the descent of the liftable parts 30, but it is not limited thereto. Other common lifting driving methods such as hydraulic pressure and linear motors can also be used. However, the structure using the gas spring 60 is simple and low in cost.

In some embodiments, the inner surface 22 of the cover 2 corresponds to and is able to close the opening 110 of the storage space 11. When the cover 2 is disengaged from the opening 110 of the storage space to open the storage space 11, the inner surface 22 can serve as the placement surface 21 after rotating around the second rotating axis 402 and the third rotating axis 403. Such a placement is more reliable because the inner surface 22 is generally a flat surface, while the outer surface 23 of the cover 2 is generally a curved surface, so the placement using the inner surface 22 is more reliable.

In some embodiments, the cover 2 is connected to the first connecting arm 31 via the rotating shaft portion 312, and the rotating shaft portion 312 has a damping torque. When the lock between the cover 2 and the shell 1 is released, the cover 2 is able to be driven by a manual opening force to overcome the damping torque, rotate around the first rotating axis 401 to the open position 203, and be held at the open position 203. The structure for maintaining the open position 203 after rotating to the open position 203 can be a hard limit such as a slot, but it is not limited thereto. It improves the structural stability of the cover 2 when used as the placement surface 21 of the tray table, further improving user experience.

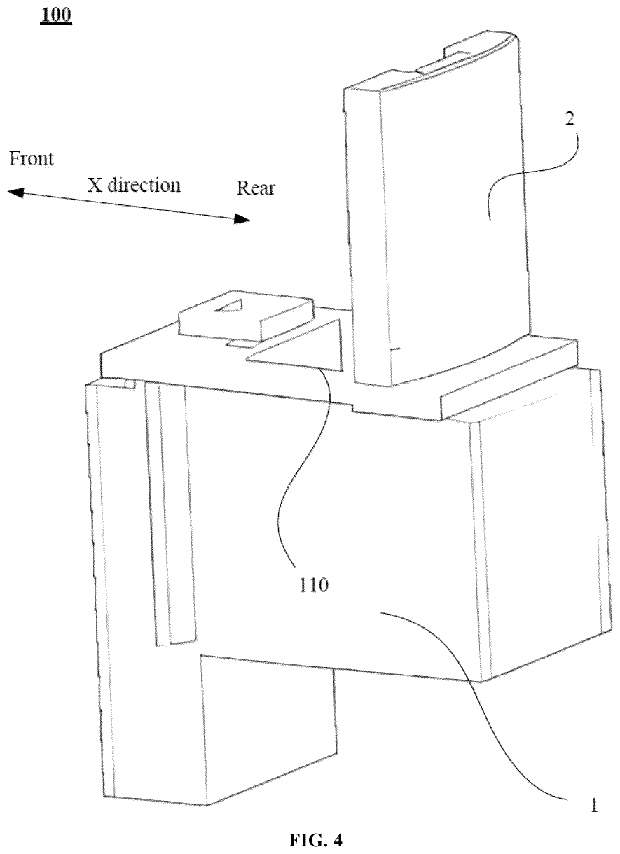

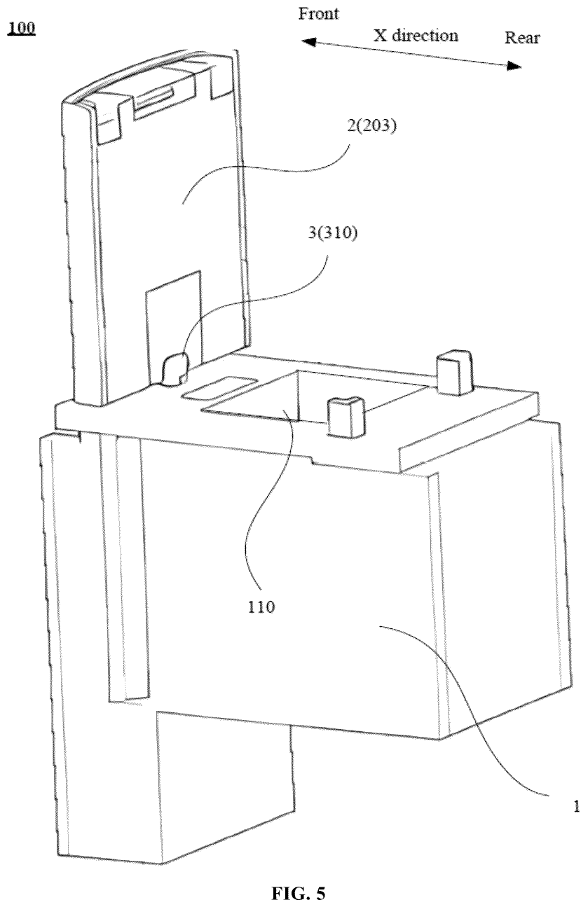

As shown in FIGS. 4 and 5, in some embodiments, the front end of the cover 2 in the first direction (X direction) is connected to the shell 1 via the first movement mechanism 310, and the rear end of the cover 2 in the first direction (X direction) is connected to the shell 1 via the second movement mechanism 320. It facilitates users in different positions, such as front-row and rear-row users, to easily open the cover 2 of the armrest assembly 100. For example, front-row users can open it at the front end in the first direction (X direction), and rear-row users can open it at the rear end in the first direction (X direction), which further improves the convenience of use.

Continuing to refer to FIGS. 6A to 6E, the structures of the first position 201 and the second position 202 is that: the first position 201 is located on one side of the boundary of the shell 1 in the second direction (Y direction), the second position 202 is located on the other side of the boundary of the shell 1 in the second direction (Y direction), and the angle between the placement surface 21 at the first position 201 and the placement surface 21 at the second position 202 is 180°. It will maximize the support range, making the placement surface 21 as close to the user as possible, further improving the user's experience.

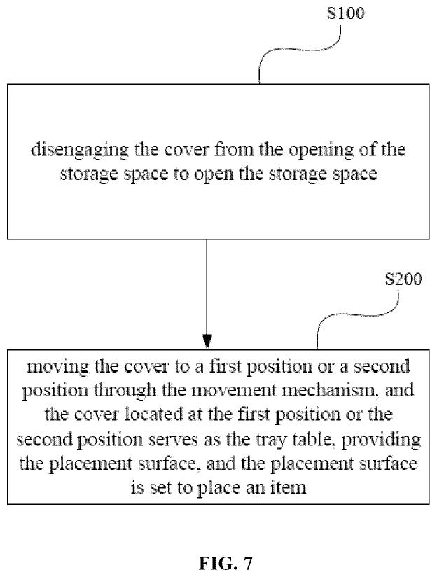

Based on the above description, referring to FIG. 7, the present disclosure also provides a method for providing a tray table, which employs the armrest assembly 100 described in the above embodiments, and the method includes the following steps.

S100. disengaging the cover 2 from the opening 110 of the storage space to open the storage space 11.

S200. Moving the cover 2 to the first position 201 or the second position 202 via the movement mechanism 3, and the cover 2 located at the first position 201 or the second position 202 serves as the tray table and provides the placement surface 21, and the placement surface 21 is able to support an item.

In summary, the beneficial effects of the armrest assembly, vehicle, and method for providing a tray table as described in the above embodiments include but are not limited to: by employing the structure where the opened cover serves as the placement surface, not only the function of the armrest assembly providing a foldable tray table is realized to improve user experience, but also the defect that the tray table occupies the storage space when folded and not in use and reduces the original storage function of the storage space is avoided, further improving user experience.

Although the present disclosure is disclosed as above with embodiments, it is not intended to limit the present disclosure. Possible changes and modifications may be made without departing from the spirit and scope of the present disclosure. Therefore, any modification, equivalent change, and modification made to the above embodiments according to the essence of the present disclosure without departing from the content of the embodiments of the present disclosure shall fall within the scope defined by the claims of the present disclosure.

What is claimed is:

1. An armrest assembly for vehicle interior, comprising:
a shell, providing a storage space;
a cover, being set correspondingly to an opening of the storage space, and the cover being connected to the shell via a movement mechanism, and the cover being able to move relative to the shell to open or close the storage space;
wherein, when the cover is disengaged from the opening of the storage space to open the storage space, the cover is able to move to a first position and/or a second position via the movement mechanism, and the cover located at the first position or the second position provides a placement surface, and the placement surface is able to support an item, and at least part of the placement surface exceeds side boundary of the shell.

2. The armrest assembly according to claim 1, wherein the movement mechanism comprises a first connecting arm and a second connecting arm, the first connecting arm being connected to the cover, and the first connecting arm comprising an arm portion extending along a third direction and a rotating shaft portion connected to the arm portion, and a first rotating axis provided by the rotating shaft portion extending in a second direction; and the first connecting arm and the second connecting arm being rotatably connected, the first connecting arm being able to rotate relative to the second connecting arm around a second rotating axis and/or around a third rotating axis, and the second rotating axis extending in the first direction, the third rotating axis extending in the third direction, and the first direction, the second direction, and the third direction being perpendicular to each other.

3. The armrest according to claim 2, wherein the first connecting arm and the second connecting arm are liftable parts in the Z direction, and when the cover is disengaged from the opening of the storage space to open the storage space, the first connecting arm and the second connecting arm can be lifted to an extended position in the Z direction, and a lifting stroke of the liftable parts is limited by a locking mechanism.

4. The armrest according to claim 2, wherein an inner surface of the cover corresponds to the opening and being able to close the storage space, and when the cover is disengaged from the opening of the storage space to open the storage space, the inner surface serves as the placement surface after rotating around the second rotation axis and around the third rotation axis.

5. The armrest according to claim 2, wherein the cover is connected to the first connecting arm through the rotating shaft portion, and the rotating shaft portion is set with a damping torque, when a lock between the cover and the shell is released, the cover is able to be driven by a manual opening force against the damping torque to rotate around the first rotation axis to an open position and be hold at the open position.

6. The armrest according to claim 2, wherein a front end of the cover in the X direction is connected to the shell through a first movement mechanism, and a rear end of the cover in the X direction is connected to the shell through a second movement mechanism.

7. The armrest member according to claim 1, wherein the first position is located on one side boundary of the shell in the Y direction, and the second position is located on the other side boundary of the shell in the Y direction, and angle between the placement surface at the first position and the placement surface at the second position is 180°.

8. A vehicle, comprising an armrest assembly for vehicle interior, comprising:
a shell, providing a storage space;
a cover, being set correspondingly to an opening of the storage space, and the cover being connected to the shell via a movement mechanism, and the cover being able to move relative to the shell to open or close the storage space;
wherein, when the cover is disengaged from the opening of the storage space to open the storage space, the cover is able to move to a first position and/or a second position via the movement mechanism, and the cover located at the first position or the second position provides a placement surface, and the placement surface is able to support an item, and at least part of the placement surface exceeds side boundary of the shell.

9. The vehicle according to claim 8, wherein the armrest assembly includes a center console armrest of a vehicle interior.

10. The vehicle according to claim 8, wherein the movement mechanism comprises a first connecting arm and a second connecting arm, the first connecting arm being connected to the cover, and the first connecting arm comprising an arm portion extending along a third direction and a rotating shaft portion connected to the arm portion, and a first rotating axis provided by the rotating shaft portion extending in a second direction; and the first connecting arm and the second connecting arm being rotatably connected, the first connecting arm being able to rotate relative to the second connecting arm around a second rotating axis and/or around a third rotating axis, and the second rotating axis extending in the first direction, the third rotating axis extending in the third direction, and the first direction, the second direction, and the third direction being perpendicular to each other.

11. The vehicle according to claim 10, wherein the first connecting arm and the second connecting arm are liftable parts in the Z direction, and when the cover is disengaged from the opening of the storage space to open the storage space, the first connecting arm and the second connecting arm can be lifted to an extended position in the Z direction, and a lifting stroke of the liftable parts is limited by a locking mechanism.

12. The vehicle according to claim 10, wherein the cover is connected to the first connecting arm through the rotating shaft portion, and the rotating shaft portion is set with a damping torque, when a lock between the cover and the shell is released, the cover is able to be driven by a manual opening force against the damping torque to rotate around the first rotation axis to an open position and be hold at the open position.

13. The vehicle according to claim 10, wherein a front end of the cover in the X direction is connected to the shell through a first movement mechanism, and a rear end of the cover in the X direction is connected to the shell through a second movement mechanism.

14. The vehicle according to claim 10, wherein a front end of the cover in the X direction is connected to the shell through a first movement mechanism, and a rear end of the cover in the X direction is connected to the shell through a second movement mechanism.

15. A method for providing a tray table, being employed for an armrest assembly of a vehicle, and the armrest assembly comprising:
a shell, providing a storage space;
a cover, being set correspondingly to an opening of the storage space, and the cover being connected to the shell via a movement mechanism, and the cover being able to move relative to the shell to open or close the storage space;
wherein, when the cover is disengaged from the opening of the storage space to open the storage space, the cover is able to move to a first position and/or a second position via the movement mechanism, and the cover located at the first position or the second position provides a placement surface, and the placement surface is able to support an item, and at least part of the placement surface exceeds side boundary of the shell;
and the method comprising following steps:
disengaging the cover from the opening of the storage space to open the storage space;
moving the cover to a first position or a second position through the movement mechanism, and the cover located at the first position or the second position serves as the tray table, providing the placement surface, and the placement surface is set to place an item.

16. The method according to claim 15, wherein the movement mechanism comprises a first connecting arm and a second connecting arm, the first connecting arm being connected to the cover, and the first connecting arm comprising an arm portion extending along a third direction and a rotating shaft portion connected to the arm portion, and a first rotating axis provided by the rotating shaft portion extending in a second direction; and the first connecting arm and the second connecting arm being rotatably connected, the first connecting arm being able to rotate relative to the second connecting arm around a second rotating axis and/or around a third rotating axis, and the second rotating axis extending in the first direction, the third rotating axis extending in the third direction, and the first direction, the second direction, and the third direction being perpendicular to each other.

17. The method according to claim 16, wherein the first connecting arm and the second connecting arm are liftable parts in the Z direction, and when the cover is disengaged from the opening of the storage space to open the storage space, the first connecting arm and the second connecting arm can be lifted to an extended position in the Z direction, and a lifting stroke of the liftable parts is limited by a locking mechanism.

18. The method according to claim 16, wherein the cover is connected to the first connecting arm through the rotating shaft portion, and the rotating shaft portion is set with a damping torque, when a lock between the cover and the shell is released, the cover is able to be driven by a manual opening force against the damping torque to rotate around the first rotation axis to an open position and be hold at the open position.
